(19) United States
(12) Patent Application Publication
(10) Pub. No.: US 2016/0023153 A1
(43) Pub. Date: Jan. 28, 2016

(54) MULTI-STAGE FILTER WITH PRESSURE RELIEF APPARATUS

(71) Applicant: David Jack Burns, Mineral Wells, TX (US)

(72) Inventor: David Jack Burns, Mineral Wells, TX (US)

(73) Assignee: PECOFACET (US), INC., Mineral Wells, TX (US)

(21) Appl. No.: 14/805,625

(22) Filed: Jul. 22, 2015

Related U.S. Application Data
(60) Provisional application No. 62/027,849, filed on Jul. 23, 2014.

(51) Int. Cl. B01D 46/00; B01D 46/44; F16K 15/02

(52) U.S. Cl. CPC B01D 46/0087; F16K 15/028; B01D 46/446; B01D 46/002

(57) ABSTRACT

A filter apparatus, a pressure relief apparatus methods are provided. The filter apparatus includes a tubular hull having an inlet port and an outlet port. A tubesheet partition separates the tubular hull interior into a first stage portion and a second stage portion. A plurality of filter elements are mounted in annular guides. A pressure relief apparatus is configured to relieve pressure through at least one of the annular guides with the pressure relief apparatus in parallel fluid circuit with the filter elements. The pressure relief apparatus includes an elongated tube, a sealing plug, an end cap, a rod disposed within the elongated tube with one end of the rod coupled to the sealing plug and another end of the rod coupled to the end cap; and a spring disposed in the elongated tube between the sealing plug and the end cap.

### CROSS-REFERENCE TO RELATED PATENT APPLICATIONS

This patent application claims the benefit of U.S. Provisional Patent Application No. 62/027,849, filed Jul. 23, 2014, the entire teachings and disclosure of which are incorporated herein by reference thereto.

### FIELD OF THE INVENTION

This disclosure relates to gas separator/coalescer filter elements in multi-stage vessels and in particular to gas separator/coalescer filter elements with pressure relief apparatus between stages.

### BACKGROUND OF THE INVENTION

Natural gas coalescer style filters commonly face process induced events that will plug the filter's filtration media very rapidly. The natural gas stream constituents, at a certain temperature and pressure, allowed a condition which precipitated natural gas hydrates. The hydrates, frozen methane ice, quickly plugged the filtration media changing a differential pressure increase up to over 100 PSI within a few minutes. Operators noticed the event, for example by installed pressure gauges in each stage of a multi-stage vessel. In some circumstances the operators don't have time to divert the gas flow or view the gauges before coalescer element and vessel internals damage occurred. Such events can be caused by hydrates, liquid slugs caused by two phase plug flow, or rapid solids loading.

The apparatus of the present disclosure must also be of construction which is both durable and long lasting, and it should also require little or no maintenance to be provided by the user throughout its operating lifetime. In order to enhance the market appeal of the apparatus of the present disclosure, it should also be of inexpensive construction to thereby afford it the broadest possible market. Finally, it is also an objective that all of the aforesaid advantages and objectives be achieved without incurring any substantial relative disadvantage.

The subject matter discussed in this background of the invention section should not be assumed to be prior art merely as a result of its mention in the background of the invention section. Similarly, a problem mentioned in the background of the invention section or associated with the subject matter of the background of the invention section should not be assumed to have recognized in the prior art. The subject matter in the background of the invention section merely represents different approaches, which in and of themselves may also be inventions.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be claimed alone or in combination with any of the features, elements, or components of any of the other embodiments discussed above.

### BRIEF SUMMARY OF THE INVENTION

The disadvantages and limitations of the background art discussed above are overcome by the present disclosure.

There is disclosed a filter apparatus including a tubular hull having an inlet port and an outlet port. A tubesheet partition within the tubular hull interior, separates the tubular hull interior into a first stage portion and a second stage portion. A plurality of filter elements are mounted in a predetermined number of annular guides. A pressure relief apparatus is configured to relieve pressure through at least one of the annular guides with the pressure relief apparatus in parallel fluid circuit with the filter elements.

The filter apparatus, in another embodiment, also provides the pressure relief apparatus as having an elongated tube configured to fit within at least one annular guide defined in the tubesheet partition. The elongated tube is in fluid communication with each stage portion of the housing. A sealing plug is configured to selectively seal one end of the elongated tube. An end cap is configured at another end of the elongated tube with a rod disposed within the elongated tube with one end of the rod coupled to the sealing plus and another end of the rod coupled to the end cap. A spring is disposed in a portion of the elongated tube between the sealing plug and the end cap along the rod. The spring is configured to exert a spring force on the sealing plug and further configured to allow the sealing plug to unseal from the elongated tube when a differential pressure between the first stage portion and the second stage portion of the housing exceeds the spring force.

The filter apparatus also includes an annular seal around the elongated tube with the seal configured to fluid seal the elongated tube to the interior wall of the annular guide in which the elongated tube is disposed.

In another embodiment, an additional annular seal is provided around the elongated tube, with one annular seal disposed proximate each end of the elongated tube.

As determined by the user, the spring force of the filter apparatus is not less than 5 PSI nor more than 50 PSI. More particularly, the spring force is not less than 15 PSI nor more than 25 PSI. In a preferred embodiment, the spring force is 20 PSI. The configuration of the spring will allow the sealing plug to fluidly open communication between the first portion and second portion of the hull when the pressure difference between the first portion and second portion of the hull equal or exceeds 20 PSI.

In another embodiment, an additional pressure relief apparatus, configured to relieve pressure between the first portion and second portion of the filter apparatus is installed in at least one other annular guide and is in parallel fluid circuit with the filter elements. The additional pressure relief apparatus is configured with a spring force the same as the other pressure relief apparatus such that both pressure relief apparatus will open fluid communication between the two portions of the filter apparatus when the predetermined pressure differential is reached. For example, both pressure relief apparatus will have a spring force of 20 PSI.

There is also provided a pressure relief apparatus controlling the pressure in a gas coalescer vessel. The coalescer vessel is configured with a tubular hull coupled to a gas supply, with the tubular hull defining a first stage portion and a second stage portion by a tubesheet partition. A plurality of two stage filter media tubes, also referred to as gas filter separator/coalescer elements, are removably arranged within a plurality of annular guides inside the tubular hull.

The pressure relief apparatus includes an elongated tube configured to fit within at least one annular guide defined in the tubesheet partition. The elongated tube is in fluid communication with each stage portion of the hull. A sealing plug is configured to selectively seal one end of the elongated tube. An end cap is configured at another end of the elongated tube, with a rod disposed within the elongated tube with one end of the rod coupled to the sealing plug and the other end of the rod coupled to the end cap.

A spring is disposed in a portion of the elongated tube between the sealing plug and the end cap along the rod. The spring is configured to exert a spring force on the sealing plug and further configured to allow the sealing plug to unseal from the elongated tube when a differential pressure between the first stage portion and second stage portion of the hull exceeds the spring force.

In another embodiment, the pressure relief apparatus includes an annular seal around the elongated tube and is configured to fluid seal the elongated tube to the interior wall of the annular guide in which the elongated tube is disposed. At least one additional annular seal around the elongated tube may be used with one annular seal disposed proximate each end of the elongated tube.

The pressure relief apparatus includes a spring force that is not less than 5 PSI nor more than 50 PSI 1 as determined by the user. A more defined spring force is not less than 15 PSI nor more than 25 PSI.

There is also disclosed a method of relieving a pressure difference between two separate portions of a filter apparatus. The filter apparatus includes a plurality of filter separator/coalescer elements extending into each of the portions through a plurality of annular guides defined in a partition fluidly separating the two separate portions of the filter apparatus hull.

The method includes removing at least one of the filter separator/coalescer elements from one of the annular guides. Installing a pressure relief apparatus into the annular guide vacated by the filter separator/coalescer element and configuring the pressure relief apparatus to open fluid communication between the two separate portions of the filter apparatus when the pressure difference between the two separate portions of the filter apparatus equal a predetermined pressure value.

In another embodiment 1 the method includes removing at least one additional filter separator/coalescer element from at least one additional annular guide and installing at least one additional pressure relief apparatus into the annular guide vacated by the at least one additional filter separator/coalescer element. The additional pressure relief apparatus is configured to open fluid communication between the two separate portions of the filter apparatus when the pressure difference between the two separate portions of the filter apparatus equal the same predetermined pressure value as configured for the other pressure relief apparatus.

In the method, the configuration of the pressure relief apparatus open fluid communication between the two separate portions of the filter apparatus when the pressure difference between the two separate portions is more than 5 PSI and less than 50 PSI.

The pressure relief apparatus in the method, includes an elongated tube configured to fit within at least one annular guide defined in the tubesheet partition with the elongated tube in fluid communication with each stage portion of the hull. A sealing plug is configured to selectively seal one end of the elongated tube. An end cap is configured at another end of the elongated tube with a rod disposed within the elongated tube with one end of the rod coupled to the sealing plug and another end of the rod coupled to the end cap.

A spring is disposed in a portion of the elongated tube between the sealing plug and the end cap along the rod, with the spring configured to exert a spring force on the sealing plug and further configured to allow the sealing plug to unseal from the elongated tube when a differential pressure between the two stage portions of the hull exceeds the spring force.

In another embodiment, the method includes fluidly sealing the pressure relief apparatus in the vacated annular guide with a chevron-type seal by mounting the chevron-type seal on the elongated tube outer circumference proximate one end of the elongated tube, with the chevron-type seal configured to press against an inside diameter of the annular guide. In a further embodiment, at least one additional chevron-type seal is mounted on the pressure relief apparatus proximate another end of the elongated tube effectively sealing the pressure relief apparatus in the annular guide.

The apparatus of the present disclosure is of a construction which is both durable and long lasting, and which will require little or no maintenance to be provided by the user throughout its operating lifetime. The apparatus of the present disclosure is also of inexpensive construction to enhance its market appeal and to thereby afford it the broadest possible market. Finally, all of the advantages and objectives are achieved without incurring any substantial relative disadvantage.

### BRIEF DESCRIPTION OF THE DRAWINGS

FIG. 1 is a side plan view of an exemplary embodiment of a multi-stage vessel for gas filter separation/coalescer elements including pressure relief apparatus.

FIG. 2 is a cross-section of the multi-stage vessel of FIG. 1 along the line 2-2.

FIG. 3 is a cross-sectional perspective view of an exemplary embodiment of a pressure relief apparatus installed in an annular guide of the multistage vessel of FIG. 1.

FIG. 4 is a cross-sectional view of the pressure relief apparatus illustrated in FIG. 3, with the pressure relief apparatus open, with a first stage portion of the multi-stage vessel in fluid communication with a second stage portion of the multi-stage vessel.

FIG. 5 is a cross-section detail view of a seal along the line 5-5 indicated in FIG. 4.

FIG. 6 is a cross-section perspective view of the pressure relief apparatus illustrated in FIG. 4.

FIG. 7 is a side elevation, in partial section, of an exemplary embodiment of a multi-stage vessel and separator/coalescer filter element.

### DETAILED DESCRIPTION OF THE INVENTION

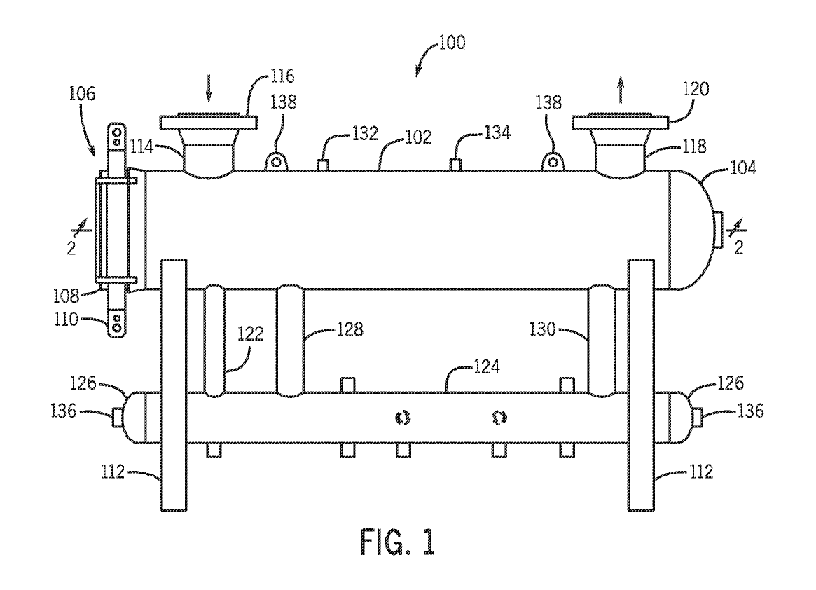

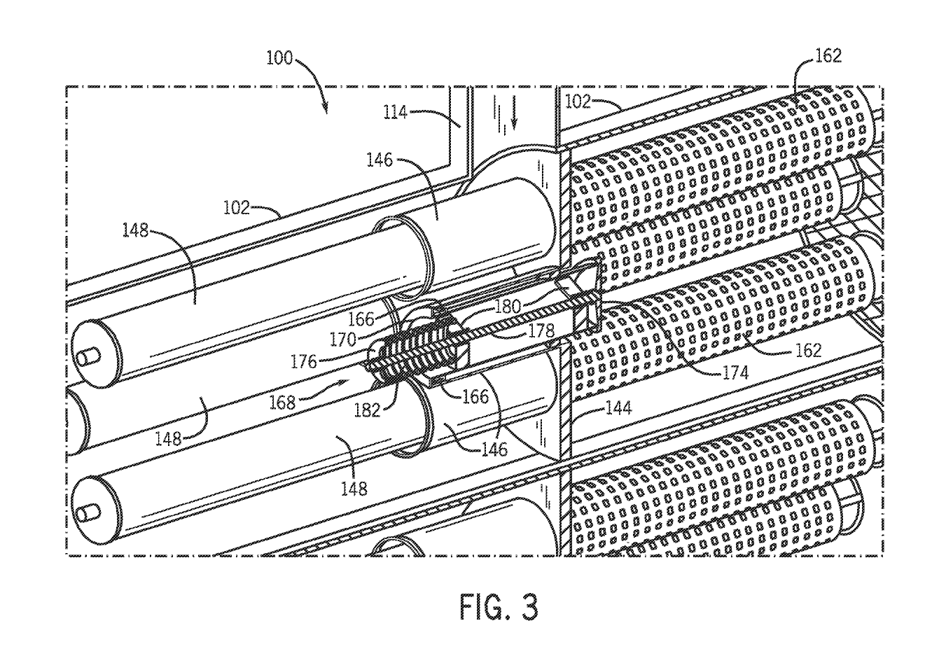

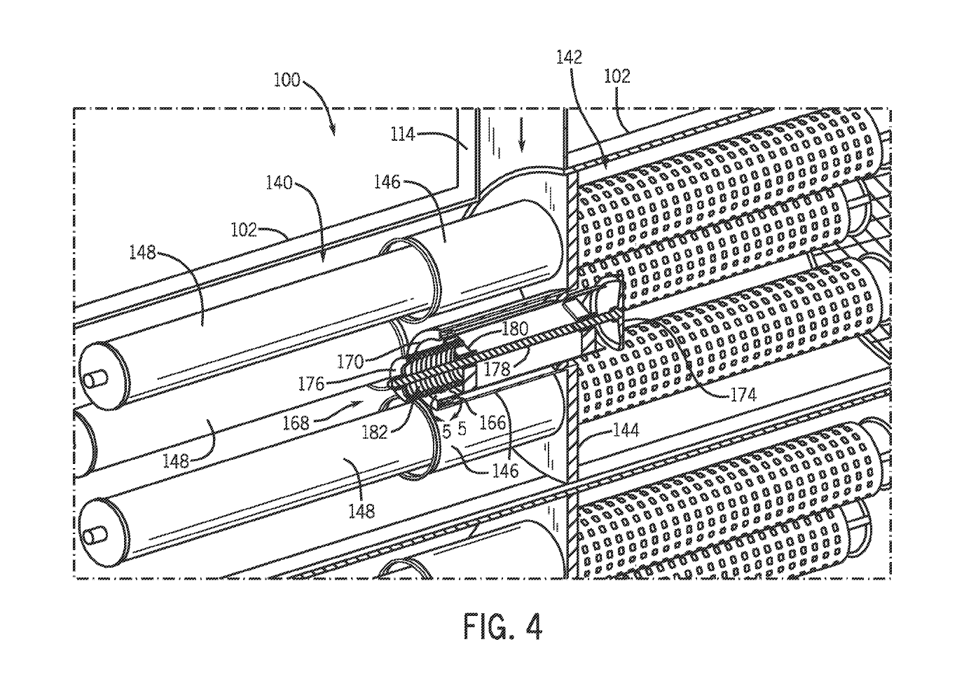

Referring to the FIGS. 1-7, FIGS. 1 and 7 of the drawings designate exemplary embodiments of a multi-stage vessel 100 for gas filter separator/coalescer elements 148. The multi-stage vessel 100 has a generally tubular hull 102 with one end permanently enclosed by a preferably eliptical cap 104 and the opposing end enclosed by a conventional closure member, preferably quick opening closure 106, consisting of a head 108 and conventional clamping means 110. Head 108 is releasably retained to multistage vessel 100 by a clamping means 110 to allow access to the interior of the hull 102 to replace and maintain gas filter separator/ coalescer elements 148 (see FIG. 1) Clamping means 110 provides a fluid tight seal between the hull 102 and the head 108 preferably with a conventional 0-ring (not shown). The hull 102 is supported at a selected height, for example by saddle supports 112.

Located on the upper side of the hull 102 near the head 108 is an inlet port 114 through which a gas stream (indicated by arrows) enters into the hull 102. The inlet port 114 terminates with a flange 116 which is fitted for connection of the multi-stage vessel 100 to conventional gas pipelines. Located on the upper side of the hull 102 near the cap 104 is an outlet port 118 through which the gas stream exits the hull 102. The outlet port 118 terminates with a flange 120 which is fitted for connection of the multi-stage vessel 100 to conventional gas pipelines. The multistage vessel 100 is preferably manufactured of steel materials which conform to published pressure vessel standards, such as ASME Boiler and Pressure Vessel Code.

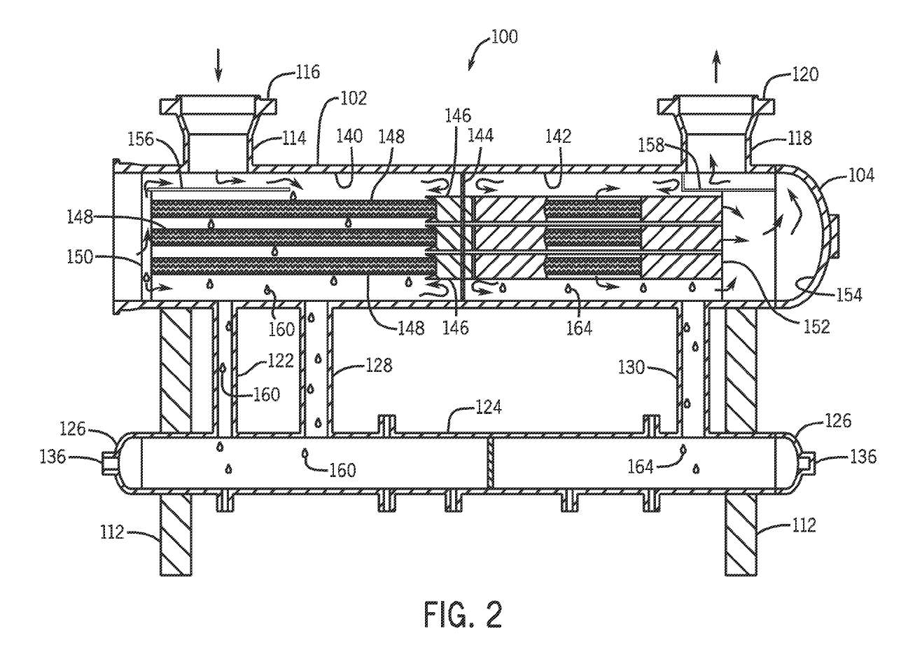

Located on the lower side of the hull 102, near the head 108 and opening into a first stage 140 (see FIG. 2), is an inlet downcomer 122 which provides fluid communication between the interior of the hull 102 and a sump 124. Sump 124 is generally tubular and is permanently enclosed on both ends by caps 126. Located on the lower side of the hull 102, and opening into the first stage 140, is a first-stage downcomer 128 which provides fluid communication between the hull 102 and the sump 124. Inlet downcomer 122 and first-stage downcomer 128 allow drainage of solids and pre-coalesced liquids which are separated at the inlet port 114 and in the first stage 140 of the multi-stage vessel 100. Located on the lower side of the hull 102, and opening into a second stage 142 (see FIG. 2), is a second-stage downcomer 130 which provides fluid communication between the hull 102 and the sump 124. Second-stage downcomer 130 allows drainage of coalesced liquids and fine liquids which are separated in the second stage 142 of the multi-stage vessel 100. Located on the upper side of the hull 102 and opening into the first stage 140 is a first-stage pressure gauge port 132 which receives a conventional pressure gauge (not shown) for monitoring the pressure or differential pressure in the first-stage 140 of the multi-stage vessel 100. Located on the upper side of the hull 102 and opening into the second-stage 142 is a second-stage pressure gauge port 134 which receives a conventional pressure gauge (not shown) for monitoring the pressure or differential pressure in the second stage 142 of the multi-stage vessel 100.

Referring now also to FIG. 2, the sump 124 is preferably divided into a first-stage compartment and a second-stage compartment by an impermeable baffle which isolates the first-stage compartment from the second-stage compartment. The first-stage compartment collects solids and liquids which are separated from the gas stream at the inlet port 114, and solids and pre-coalescer liquids which are separated from the gas stream in the first stage 140 of the multi-stage vessel 100. The second-stage compartment collects coalesced liquids and fine liquids which are separated from the gas stream in the second stage 142 of the multi-stage vessel 100.

Located opposite each other on the upper and lower sides of sump 124 and opening into the first-stage compartment are first-stage compartment gauge glass connections which receive a conventional gauge glass (not shown) for monitoring the liquid level in the first-stage compartment. Located opposite each other on the upper and lower sides of sump 124 and opening into the second-stage compartment are second-stage compartment gauge glass connections which receive a conventional gauge glass (not shown) for monitoring the liquid level in the second-stage compartment. Located on the lower and back sides of sump 124 and opening into the first-stage compartment is a plurality of first-stage compartment connections, operated by valves (not shown), for draining or siphoning solids, liquids, and pre-coalesced liquids out of the first-stage compartment of the sump 124.

Sump caps 126 contain clean-out ports 136, operated by valves (not shown), which open into the first-stage compartment and the second-stage compartment to allow insertion of level control instruments and other measuring devices into the first-stage compartment and the second-stage compartment. Permanently attached to the upper side of the hull 102 is the plurality of eyelets 138 for hoisting the multi-stage vessel 100 during manufacture, transportation, installation, and maintenance.

Referring now to FIG. 2 in the drawings, the multi-stage vessel 100 is shown divided into the first stage portion 140 and the second stage portion 142 by a partition, or tubesheet 144. Tubesheet 144 forms a fluid-tight seal around the interior wall of the hull 102 and has a plurality of annular guides 146 through which the gas filter separator/coalescer elements 148 pass from the first stage portion 140 to the second stage portion 142. The tubesheet 144 and the guides 146 are preferably made of steel.

The gas filter separator/coalescer elements 148 extend longitudinally along the length of the first stage portion 140 from a first stage support screen 150 to the tubesheet 144. The gas filter separator/coalescer elements pass through the guides 146 of the tubesheet 144 and extend longitudinally along the length of the second stage portion 142 to a second stage support screen 152. First stage support screen 150 and second stage support screen 152 are both preferably made of a rigid material, such as steel or expanded metal, but are perforated to allow the gas stream to flow through them. The gas stream passes through an annular space 154 between the second stage support screen 152 and the interior of the cap 104 prior to exiting through the outlet port 118.

Gas enters port 114 and is directed by inlet baffle 156 into the first stage portion 140. The gas then impacts the element guides 146. As the gas impacts guide 146, the gas is distributed across the open volume of the first stage portion 140 which slows the gas velocity allowing solids and liquid contaminants to fall out of the gas and drain, by gravity, to the first stage downcomers 122 and 128. This action separates some of the liquids and solids from the incoming gas stream and directs the gas stream over the gas filter separator/coalescer elements 148. In the first stage portion 140, the gas stream is forced through the sidewalls of the gas filter separator/coalescer elements 148 from the outside to the inside. The gas filter separator/coalescer elements 148 trap solids and precoalescer liquids from the gas stream creating a pressure drop across the sidewalls of the gas filter separator/coalescer elements 148. Outlet baffle 158, located within the second stage portion 142, extends down from the upper interior wall of the second stage 142 and longitudinally across the outlet port 118 into the annular space 154. Outlet baffle 158 directs the gas stream into the annular space 154 and out the outlet port 118.

The selected density and porosity of the gas filter separator/coalescer elements 148 prevent solids and bulk liquids from passing through the gas filter separator/coalescer element 148 and into the second stage 142 of the multi-stage vessel 100. Droplets 160 of solids and liquids separated by impaction with guides 146 and flow through the inlet downcomer 122 and the first-stage downcomer 128 into the first-stage compartment of the sump 124. Droplets 160 of precoalesced liquids separated by the gas filter separator/coalescer elements guides 146 drip off the guides and flow through the inlet downcomer 122 and the first-stage downcomer 128 into the first-stage compartment of the sump 124. When the droplets 160 comprised of solids and pre-coalesced fluids in the first-stage compartment reach a selected level, as indicated by the gauge glass connected to gauge glass connections, the solids and pre-coalesced fluids are drained or siphoned out of the first-stage compartment of the sump 124 through the first-stage compartment connections. Drainage can also be accomplished by utilizing automatic liquid level control instrumentation (not shown).

The gas stream passes from the first stage portion 140 through the tubesheet 144 and into the second stage portion 142 along the interior of the gas filter separator/coalescer elements 148. In the second stage portion 142, the gas stream is forced through the sidewalls of the gas filter separator/coalescer elements 148 from the inside to the outside. The gas filter separator/coalescer elements 148 coalescer liquids from the gas stream creating a pressure drop across the sidewalls of the gas filter separator/coalescer elements 148. In the second stage portion 142, each gas filter separator/coalescer element 148 is concentrically surrounded by a tubular flow diffuser 162 which is attached at one end to a guide 146 of the tubesheet 144 and at the opposing end to the second-stage support screen 152. The flow diffusers 162 are preferably manufactured from a perforated steel and are dimensioned such that there is a selected clearance between each gas filter separator/coalescer element 148 and the corresponding flow diffuser 162.

As the gas stream passes through the gas filter separator/coalescer elements 148 in the second stage 142, fine droplets of liquid 164 coalescer on the fibers of the gas filter separator/coalescer elements 148. As the gas stream exits the gas filter separator/coalescer elements 148, flow diffusers 162 prevent droplets 164 from being re-entrained into the gas stream. Coalescer liquid droplets 164 drip from the gas filter separator/coalescer elements 148 and the flow diffusers 162 and flow through the secondstage downcomer 130 into the second-stage compartment of the sump 124. When the collected droplets 164 of coalescer fluid and fine liquids in the second-stage compartment reach a selected level, as indicated by the gauge glass connected to the gauge glass connections, the coalescer fluids and fine liquids are drained or siphoned out of the second-stage compartment of the sump 124 through the second-stage compartment connections.

An annular sealing cap provides a fluidtight seal at each end of each gas filter separator/coalescer element 148. The sealing caps are permanently attached to element 148. The sealing caps have protrusions which protrude into flow diffuser 162 and support screen 150, to center the gas filter separator/coalescer elements 148.

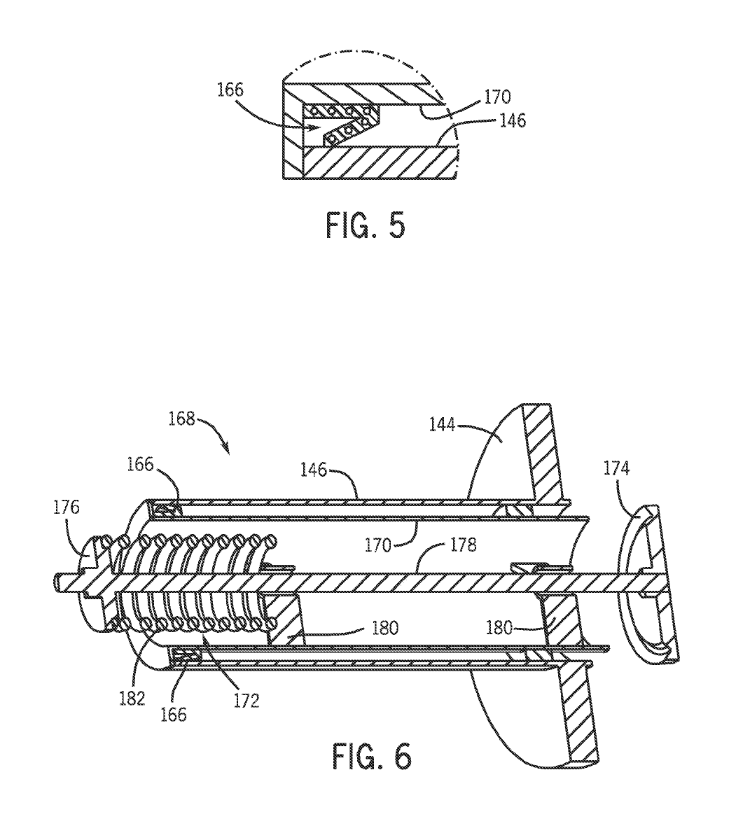

Referring now to FIG. 5 in the drawings, numeral 166 illustrates an annular chevron-type seal which surrounds the gas filter separator/coalescer element 148 and is compressed between the gas filter separator/coalescer element 148 and the guides 146 of the tubesheet 144. The chevron-type seal provides a fluid-tight seal between the first stage portion 140 and the second stage portion 142 of the multi-stage vessel. The chevron-type seal is preferably made of an elastomer. The chevron-type seal 166 allows a single tubular gas filter separator/coalescer element 148 to filter solids and pre-coalescer liquids as the gas stream flows from outside to inside in the first stage 140 of the multi-stage vessel 100, and simultaneously coalescer fluids and fine liquids as the gas stream flows from inside to outside in the second stage 142 of the multi-stage vessel 100. The chevron-type seal 166 is also used to seal a pressure relief apparatus 168 in one of the annular guides 146 after removal of one of the gas filter separator/coalescer element 148.

In one embodiment of the multi-stage filter 100, when the pressure drop across the multi-stage vessel 100, as indicated by the pressure gauges connected at the first-stage pressure gauge port 132 and the second-stage pressure gauge port 134, reaches a selected value, the gas filter separator/coalescer elements 148 are removed and discarded. The gas filter separator/coalescer elements 148 are removed by releasing the clamping means 110, opening the head 108 of the quick opening closure 106. The first-stage support screen 150 is removed to expose the elements 148. The gas filter separator/coalescer elements 148 are then extracted from the multi-stage vessel 100 for replacement. Replacement gas filter separator/coalescer elements 148 are inserted through the guides 146 of the tubesheet 144. Insertion of the elements 148 automatically seal the elements. The first-stage support screen 150 is replaced to support the elements 148. The quick opening closure is then closed and sealed with the clamping means 110 and the multi-stage vessel 100 is ready for use again.

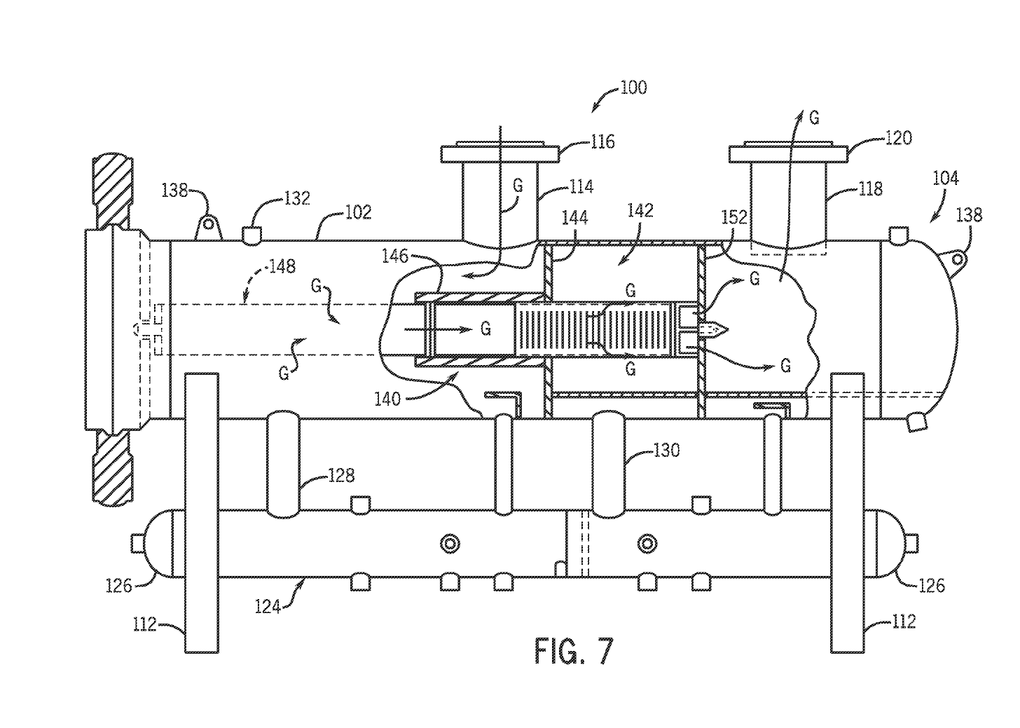

FIG. 7 illustrates an exemplary embodiment of a multi-stage filter 100. A more complete filter is in issued which is incorporated description of the U.S. Pat. No. illustrated 6,168,647 herein, in its entirety, by this reference.

In another embodiment of the multi-stage filter 100, a pressure relief apparatus 168 is installed. One of the gas filter separator/coalescer element 148 is removed and a pressure relief apparatus 168 is installed in the annular guide 146 vacated by the gas filter element 148. The pressure relief apparatus 168 can be installed in either of the embodiments of the multi-stage filter illustrated in FIGS. 1 and 7.

The pressure relief apparatus 168 controls the pressure in the gas coalescer vessel 100. As indicated above, there are times when an operator does not notice the pressure differential between the first stage portion 140 and the second stage portion 142 of the hull 102 on the pressure gauges coupled to each of the stages 140,142 of the hull 102. As a result, the pressure inside the hull 102 can quickly increase to over 100 psi. Depending on the specific application and location of the multi-stage vessel 100, typical pressures between the multi-stages of the vessel, can range between 5 psi to 50 psi. In a typical operation, once the pressure differential reaches 15 psi between stages an operator will institute maintenance procedures as described above, wherein the gas filter elements 148 will be replaced or cleaned. However, as also indicated above, there are certain instances when an operator does not notice the differential pressure between stages of a multi-stage vessel or perhaps any sensors that are utilized are not functioning properly and the pressure build up between stages can be catastrophic. In accord with the present disclosure, a pressure relief apparatus 168 is installed in the vessel 100 with the pressure relief apparatus configured to operate when a selected pressure differential is reached.

The pressure relief apparatus 168 includes an elongated tube 170 configured to fit within at least one annular guide 146 defined in the tubesheet partition 144. The elongated tube 170 is in fluid communication with each stage 140, 142 of the hull 102. A sealing plug 174 is configured to selectively seal one end of the elongated tube 170. An end cap 176 is configured at the other end of the elongated tube 170. The sealing plug 174 and the end cap 176 are coupled to a rod 178 disposed within the elongated tube 170 with one end of the rod 178 coupled to the sealing plug 174 and another end of the rod 178 coupled to the end cap 176. Rod supports 180 are coupled to the interior of the elongated tube 170 to support the rod 178 at least proximate each end of the rod. The spring 182 is disposed in a portion 172 of the elongated tube 170 between the sealing plug 174 and the end cap 176 along the rod 178. The spring typically is coupled to the end cap 176 with the spring configured to exert a pulling force on the sealing plug 178. The spring force of the spring 182 pulls the sealing plug 178 against the elongated tube 170 effectively sealing the sealing plug 178 against the elongated tube 170 and cutting off fluid communication, through the elongated tube between stages 140, 142 of the multi-stage vessel 100.

The spring is also configured to allow the sealing plug 174 to unseal from the elongated tube 170 when a differential pressure between the first stage portion 140 and the second stage portion 142 of the hull 102 exceeds the spring force. The spring 182 is selected, typically a coil spring, to have a spring force that is equal to, within typical manufacturing tolerances, the selected pressure differential between the stages 140, 142 of the multi-stage vessel 100. It should be understood that the spring selected, by the user, can be within the range of 5-50 psi but in a typical configuration, the spring force is not less than 20 psi.

The elongated tube 170 is fluidly sealed in the annular guide 146 by an annular seal around the elongated tube and configured to fluid seal the elongated tube to the interior wall of the annular guide 146 in which the elongated tube 170 is disposed. As discussed above, the annular seal typically is the chevron-type seal 166. The chevron-type seal 166 is installed proximate each end of the elongated tube 170.

In another embodiment, multiple pressure relief apparatuses 168 may be installed in several annular guides 146 to ensure that the pressure differential does not exceed the selected pressure differential under which the pressure relief apparatus 168 will operate. Multiple pressure relief apparatus facilitate rapid depressurization within the vessel 100. It should also be understood that once the pressure differential between the multi-stages 140, 142 are at or below the pre-selected pressure differential, the spring will again reseal the sealing plug 174 against the elongated tube 170 effectively fluidly sealing fluid flow between the multiple stages of the multi-stage vessel 100.

The gas filter separator/coalescer elements 148 for use in the present filter are preferably constructed in the manner and of the materials disclosed in U.S. Pat. No. 5,827,430, which disclosure is incorporated by reference herein. For example, in a typical application, the gas filter separator/coalescer elements 148 consist of four multi-overlapped layers of nonwoven fabric strip of varying composition.

The gas filter separator/coalescer elements 148 and the multi-stage vessel 100 thus manufactured can coalescer and remove 99.5% of all liquid droplets 0.3 microns and larger and can remove 99.99% of all solid particles 0.3 microns and larger at a combined pressure drop across the multi-stage vessel 100 of approximately one to three pounds per square inch gauge.

Although the multi-stage vessel 100 has been shown in a generally horizontal configuration, it should be apparent that the multi-stage vessel 100 may be configured in a generally vertical embodiment with the inlet port 114 located on the lower end and the outlet port 118 located on the upper end. In the vertical embodiment, sump 124 may be optional, in that the separated and coalesced fluids may be collected in the interior of vessel 100. It should be apparent from the foregoing disclosure has significant advantages has been provided. While the gas separator filter with pressure relief apparatus is shown in only one of its forms, it is not just limited but is susceptible to various changes and modifications without departing from the spirit thereof.

For purposes of this disclosure, the term “coupled” means the joining of two components (electrical or mechanical) directly or indirectly to one another. Such joining may be stationary in nature or moveable in nature. Such joining may be achieved with the two components (electrical or mechanical) and any additional intermediate members being integrally formed as a single unitary body with one another or the two components and any additional member being attached to one another. Such adjoining may be permanent in nature or alternatively be removable or releasable in nature.

Although the foregoing description of the present filter with pressure release apparatus has been shown and described with reference to particular embodiments and applications thereof, it has been presented for purposes of illustration and description and is not intended to be exhaustive or to limit the disclosure to the applications disclosed. having ordinary skill particular embodiments and It will be apparent to those in the art that a number of changes, modifications, variations, or alterations to the apparatus as described herein may be made, none of which depart from the spirit or scope of the present disclosure. The particular embodiments and applications were chosen and described to provide the best illustration of the principles of the apparatus disclosed and its practical application to thereby enable one of ordinary skill in the art to utilize the various embodiments and with various modifications as are suited to the particular use contemplated. All such changes, modifications, variations, and alterations should therefore be seen as being within the scope of the present disclosure as determined by the appended claims when interpreted in accordance with the breadth to which they are fairly, legally, and equitably entitled.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context

What is claimed is:

1. A filter apparatus comprising:
a tubular hull having an inlet port and an outlet port;
a tubesheet partition within the tubular hull interior, the tubesheet partition separating the tubular hull interior into a first stage portion and a second stage portion;
plurality of filter elements mounted in a predetermined number of annular guides; and
a pressure relief apparatus configured to relieve pressure through at least one of the annular guides, in parallel fluid circuit with the filter elements.

2. The filter apparatus of claim 1, further
comprising the pressure relief apparatus comprising:
an elongated tube configured for fit within 4 at least one annular guide defined in the tube sheet partition, the elongated tube in fluid communication with each stage portion of the housing;
a sealing plug configured to selectively seal one end of the elongated tube;
an end cap configured at another end of the enlongated tube;
a rod disposed within the enlongated tube with one end of the rod coupled to the sealing plug and another end of the rod coupled to the end cap; and
a spring disposed in a portion of the enlongated tube between the sealing plug and the end cap along the rod, with the spring configured to exert a spring force on the sealing plug and further configured to allow the sealing plug to unseal from the enlongated tube when a differential pressure between the first stage portion and second stage portion of the housing exceeds the spring force.

3. The filter apparatus of claim 2, further comprising an annular seal around the elongated tube and configured to fluid seal the elongated tube to the interior wall of the annular guide in which the elongated tube is disposed.

4. The filter apparatus of claim 3, further comprising at least one additional annular seal around the elongated tube, with one annular seal disposed proximate each end of the elongated tube.

5. The filter apparatus of claim 1, wherein the spring force is not less than 5 PSI nor more than 50 PSI.

6. The filter apparatus of claim 5, wherein the spring force is not less than 15 PSI nor more than 25 PSI.

7. The filter apparatus of claim 1, further comprising an additional pressure relief apparatus configured to relieve pressure through at least one other of the annular guides, in parallel fluid circuit with the filter elements.

8. A pressure relief apparatus controlling pressure in a gas coalescer vessel, the coalescer configured with a tubular hull coupled to a gas supply, with the tubular hull defining a first stage portion and a second stage portion by a tubesheet partition and a plurality of two stage filter media tubes removably arranged within a plurality of annular guides in the tubular hull, the pressure relief apparatus comprising:
an elongated tube configured for fit within at least one annular guide defined in the tubesheet partition, the elongated tube in fluid communication with each stage portion of the hull;
a sealing plug configured to selectively seal one end of the elongated tube;
an end cap configured at another end of the elongated tube;
a rod disposed within the elongated tube with one end of the rod coupled to the sealing plug and another end of the rod coupled to the end cap; and
a spring disposed in a portion of the elongated tube between the sealing plug and the end cap along the rod, with the spring configured to exert a spring force on the sealing plug to unseal from the elongated tube when a differential pressure between the first stage portion and second stage portion of the hull exceeds the spring force.

9. The pressure relief apparatus of claim 9, further comprising an annular seal around the elongated tube and configured to fluid seal the elongated tube to the interior wall of the annular guide in which the elongated tube is disposed.

10. The pressure relief apparatus of claim 9, further comprising at least one additional annular seal around the elongated tube, with one annular seal disposed proximate each end of the elongated tube.

11. The pressure relief apparatus of claim 8, wherein the spring force is not less than 5 PSI nor more than 50 PSI.

12. The pressure relief apparatus of claim 11, wherein the spring force is not less than 15 PSI nor more than 25 PSI.

13. A method of relieving a pressure difference between two separate portions of a filter apparatus, the filter apparatus including a plurality of filter separator/coalescer elements extending into each of the portions through a plurality of annular guides defined in a partition fluidly separating the two separate portions of the filter apparatus hull, the method comprising:
removing at least one of the filter separator/coalescer elements from one of the annular guides;
the installing a pressure relief annular guide vacated by separator/coalescer element; and
configuring the pressure relief apparatus to open fluid communication between the two separate portions of the filter apparatus when the pressure difference between the two separate portions of the filter apparatus equal a predetermined pressure value.

14. The method of claim 13, further comprising:
removing at least one additional filter separator/coalescer element from at least one additional annular guide;
install at least one additional pressure relief apparatus into the annular guide vacated by the at least one additional filter separator/coalescer element; and
configuring the additional pressure relief apparatus to open fluid communication between the two separate portions of the filter apparatus when the pressure difference between the two separate portions of the filter apparatus equal the same predetermined pressure value as configured for the other pressure relief apparatus.

15. The method of claim 13, wherein the pressure relief apparatus is configured to open fluid communications between the two separate portion of the filter apparatus when the pressure difference between the two separate portions is more than 5 PSI and less than 50 PSI.

16. The method of claim 13, the pressure relief apparatus comprises:
an elongated tube configured for fit within at least one annular guide defined in the tube sheet partition, the elongated tube in fluid communication with each stage portion of the hull;
a sealing plug configured to selectively seal one end of the elongated tube;
an end cap configured at another end of the elongated tube;
a rod disposed within the elongated tube with one end of the rod coupled to the sealing plug and another end of the rod coupled to the end cap; and
a spring disposed in a portion of the elongated tube between the sealing plug and the end cap along the rod, with the spring configured to exert a spring force on the sealing plug and further configured to allow the sealing plug to unseal from the elongated tube when a differential pressure between the first stage portion and second stage portion of the hull exceeds the spring force.

17. The method of claim 16, wherein the spring force is not less than 5 PSI nor more than 50 PSI.

18. The method of claim 17, wherein the spring force is not less than 15 PSI nor more than 25 PSI.

19. The method of claim 16, further comprises fluidly sealing the pressure relief apparatus in the vacated annular guide with a chevron-type seal by mounting the chevron-type seal on the elongated tube outer circumference proximate one end of the elongated tube, with the chevron-type seal configured to press against an inside diameter of the annular guide.

20. The method of claim 19, further comprising mounting at least one additional chevron-type seal on the pressure relief apparatus proximate another end of elongated tube.
